(19) United States
(12) Patent Application Publication
(10) Pub. No.: US 2009/0155114 A1
(43) Pub. Date: Jun. 18, 2009

(54) COMPRESSOR STRUCTURE FOR A REFRIGERATION SYSTEM

(75) Inventors: Hoe Chuan Kwan, Singapore (SG); Kok How Wan, Singapore (SG)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: MATSUSHITA ELECTRIC INDUSTRIAL CO., LTD., Osaka (JP)

(21) Appl. No.: 11/719,733

(22) PCT Filed: Jan. 11, 2007
(86) PCT No.: PCT/SG2007/000009

§ 371 Date: May 18, 2007

(30) Foreign Application Priority Data
Sep. 12, 2006 (SG) 200606304-4

(51) Int. Cl. F04C 29/00; F04C 29/06; B23P 17/00

(52) U.S. Cl. 418/179; 417/312; 29/592

(57) ABSTRACT

A compressor structure for a refrigeration system and a component for a refrigeration system. The compressor structure comprises a compression cylinder; a suction line leading gas to be compressed towards the cylinder; and a discharge line leading the compressed gas away from the cylinder; wherein at least one component of the suction line, the discharge line, or both comprises a thermal barrier layer on a surface of the at least one component.

### FIELD OF INVENTION

The present invention broadly relates to a compressor structure for a refrigeration system, to a component for a compressor structure for a refrigeration system, and to a method of fabricating a compressor structure for a refrigeration system.

### BACKGROUND

Gas-compression refrigeration has been and still is the most widely used method for fridges and air-conditioning of large public buildings, private residences, hotels, hospitals, theatres, restaurants and automobiles etc. The gas-compression refrigeration system uses a circulating refrigerant as a medium, which absorbs and removes heat from a location or space to be cooled and subsequently dissipates the heat elsewhere.

A typical gas-compression system has four components: a compressor, a condenser, an expansion valve (also called a throttle valve), and an evaporator. The compressor sucks low-temperature and low-pressure saturated gas from the evaporator and compresses the gas to high-pressure, resulting in higher temperature as well. To improve the volumetric and energetic efficiencies of the compressor, which is to draw larger volume of the gas within a compressor's single compression cycle, it is desired to thermally insulate the drawn low-temperature gas from hotter parts of the compressor so that the low-temperature gas from the evaporator can be pumped in larger volume when its temperature is kept low.

There are many components along the suction line. These components include a muffler, a cylinder head, and some pipelines, etc. Inside a commonly adopted reciprocating compressor for a refrigeration system, the muffler is usually provided inside the compressor shell at a gas suction side for conducting the received gas to a suction valve of the compressor. The muffler also dampens acoustic vibration of the compressor and thermally insulates the received low-temperature gas from other hotter parts of the compressor.

However, it is difficult to prevent heat exchange between the low-temperature gas and other hotter parts of the compressor because the drawn gas is present in the compressor within a narrow space and short distances from the hotter parts of the compressor.

Many attempts have been made to improve thermal insulation for the muffler. For example, mufflers are manufactured from materials of low thermal conductivity, such as resins or plastics. Recently, there are also some structural approaches to improve thermal insulation of the muffler.

One suction muffler suggested in WO02/101239A1 has designed two acoustic chambers for refrigerant gas communication inside a muffler. In particular, a first acoustic chamber of the muffler, which directly receives low-temperature gas outside the compressor, is surrounded by a second acoustic chamber of the muffler. This structure provides additional thermal insulation to the received low-temperature gas in the first acoustic chamber because heat flow from the exterior has to cross surrounding walls of the second acoustic chamber to reach the low-temperature gas inside the first acoustic chamber. However, the design of two acoustic chambers complicates the internal structure of the muffler and increases the muffler's size which also adversely affects the manufacturing cost of the muffler. Furthermore, the structural strength and reliability of the muffler may be compromised.

A need therefore exists to provide structure for a refrigeration system that seeks to address at least one of the above problems.

### SUMMARY

According to a first aspect of the present invention, there is provided a compressor structure for a refrigeration system, the compressor structure comprising a compression cylinder, a suction line leading gas to be compressed towards the cylinder, and a discharge line leading the compressed gas away from the cylinder, wherein at least one component of the suction line, the discharge line, or both comprises a thermal barrier layer on a surface of the at least one component.

The thermal barrier layer may be disposed on an external surface of the component.

The thermal barrier layer may be disposed on an internal surface of the component.

The thermal barrier layer may comprise a coating formed on the surface.

The thermal barrier layer may comprise a thermally insulating material.

The thermally insulating material may comprise one or more of a group consisting of a ceramic material, AlO, ZrO and Al2O3.

The component may comprise a suction muffler or a cylinder head.

The coating may be formed on an internal surface of a suction plenum, a discharge plenum, or both, of the cylinder head.

The coating may be formed on an external surface of the suction muffler.

The thermal barrier layer may comprise an air layer between adjacent walls of a multilayer wall structure of the component.

The component may comprise a suction muffler.

According to a second aspect of the present invention, there is provided a component for integration in a suction line, a discharge line, or both, of a compressor structure for a refrigeration system, the component comprising a thermal barrier layer on a surface of the component.

The thermal barrier layer may be disposed on an external surface of the component.

The thermal barrier layer may be disposed on an internal surface of the component.

The thermal barrier layer may comprise a coating formed on the surface.

The thermal barrier layer may comprise a thermally insulating material.

The thermally insulating material may comprise one or more of a group consisting of a ceramic material, AlO, ZrO and Al₂O₃.

The component may comprise a suction muffler or a cylinder head.

The coating may be formed on an internal surface of a suction plenum, a discharge plenum, or both, of the cylinder head.

The coating may be formed on an external surface of the suction muffler.

The thermal barrier layer may comprise an air layer between adjacent walls of a multilayer wall structure of the component.

The component may comprises a suction muffler.

In accordance with a third aspect of the present invention there is provided a method of fabricating a compressor structure for a refrigeration system, the method comprising providing a compression cylinder; providing a suction line leading gas to be compressed towards the cylinder; providing a discharge line leading the compressed gas away from the cylinder; and forming a thermal barrier layer on a surface of at least one component of the suction line, the discharge line, or both.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic diagram illustrating a temperature profile of a refrigerant gas path inside a reciprocating compressor;

FIG. 2 shows a generally isometric view of a cylinder head with both suction and discharge plenums coated with a layer of ceramic thermal insulating material; and

FIG. 3 shows a generally isometric view of a cylinder head with the discharge plenum; and

FIG. 4 shows a suction muffler with its external surface coated with a thermally insulating material, in which (a) is a front view of the muffler; (b) is a side view of the muffler and (c) is a generally isometric view of the muffler.

### DETAILED DESCRIPTION

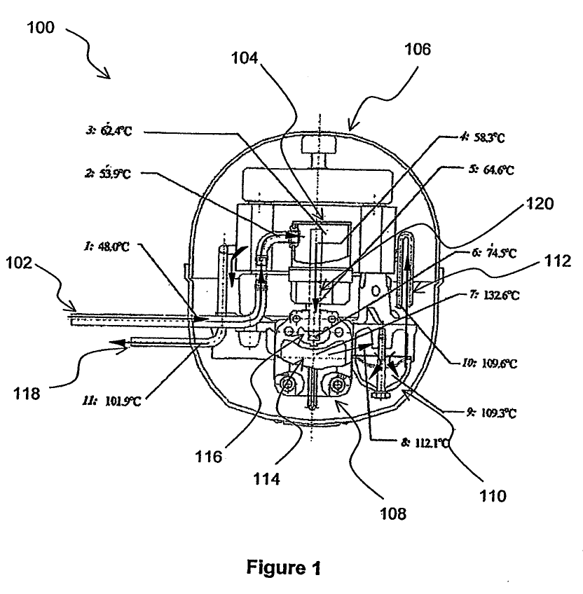

Referring to FIG. 1, the interior of a compressor 100 for hermetic gas-compression refrigeration is exposed for indicating a temperature profile of a refrigerant gas along its travelling path inside the compressor 100. The compressor 100 comprises a suction inlet pipeline 102, a suction muffler 104, and a cylinder head 108. The suction muffler 104 is disposed inside the shell 106 of the compressor 100. The suction muffler 104 connects to the cylinder head 108 which has a suction plenum 116 and a discharge plenum 114 at its interior. The suction plenum 116 receives the gas with lower temperature while the discharge plenum 114 receives the compressed gas from the cylinder chamber (hidden) at higher temperature. The suction plenum 116 and the discharge plenum 114 are connected to a cylinder chamber (hidden) via a suction valve and a discharge valve (not shown) respectively. The discharge plenum 114 is further connected to the discharge pipeline 118 of the compressor 100 via muffler cover discharge 110 and discharge line 112 for discharging compressed gas at high temperature for the refrigeration system.

Along the travelling passage inside the compressor 100, initially, the low-temperature refrigerant gas is drawn into the suction muffler 104 via the suction inlet pipeline 102, either directly or indirectly. At the entrance of the inlet pipeline 102 going into the shell 106 (point 1), the gas has the lowest temperature inside the compressor shell 106, typically at about 48.0 degree Celsius. When the gas is drawn further towards the muffler 104, it is heated up by the surroundings to typically about 53.9 degree Celsius at the entrance (point 2) of the muffler 104. Inside the muffler 104, the gas temperature is typically further raised to about 62.4 degree Celsius (point 3) before reaching the cylinder head 108. Inside a conduit tail pipe 120 linking the suction muffler 104 and the cylinder head 108, the gas is typically increased to about 64.6 degree Celsius (point 5). Further down the travelling path where the gas arrives at the suction plenum 116 of the cylinder head 108, the temperature of the gas has typically reached about 74.5 degree Celsius (point 6). The gas is then drawn via the suction valve (not shown) to be compressed in the cylinder chamber (hidden). The compressed gas leaves via the discharge valve (not shown) and enters the discharge plenum 114 of the cylinder head 108. Inside the discharge plenum 114, the temperature of the compressed gas is typically about 132.6 degree Celsius (point 7). On leaving the cylinder head 108, the gas starts to cool down. Along the down stream path via muffler cover discharge 110 and discharge line 112, and discharge pipeline 118 of the compressor 100, the high temperature and high pressure gas typically cools to about 101.9 degree Celsius at the point (point 11) where the discharge pipeline exits the shell 106.

It is evident that the gas has a large temperature difference between the adjacent suction and discharge plenums 116, 114. It has been recognised by the applicant that the high temperature gas contained in the discharge plenum 114 constitutes a heat source which can significantly contribute to the temperature increase in the low temperature suction refrigerant gas in the suction plenum 116 prior to compression. The increase in the suction refrigerant gas temperature causes an increase in its specific volume and reduces the mass flow rate of the refrigerant gas, which in turn leads to a drop in the compressor's efficiency due to a reduction in cooling performance. It is noted that the high temperature compressed gas in the discharge plenum 114, as well as other heat sources within the compressor structure 100, also contributes to the overall temperature increase in the suction gas as the gas travels from the inlet pipe 102 via the muffler 104 into the suction plenum 116, which can further contribute to an overall increase in the suction refrigerant gas temperature.

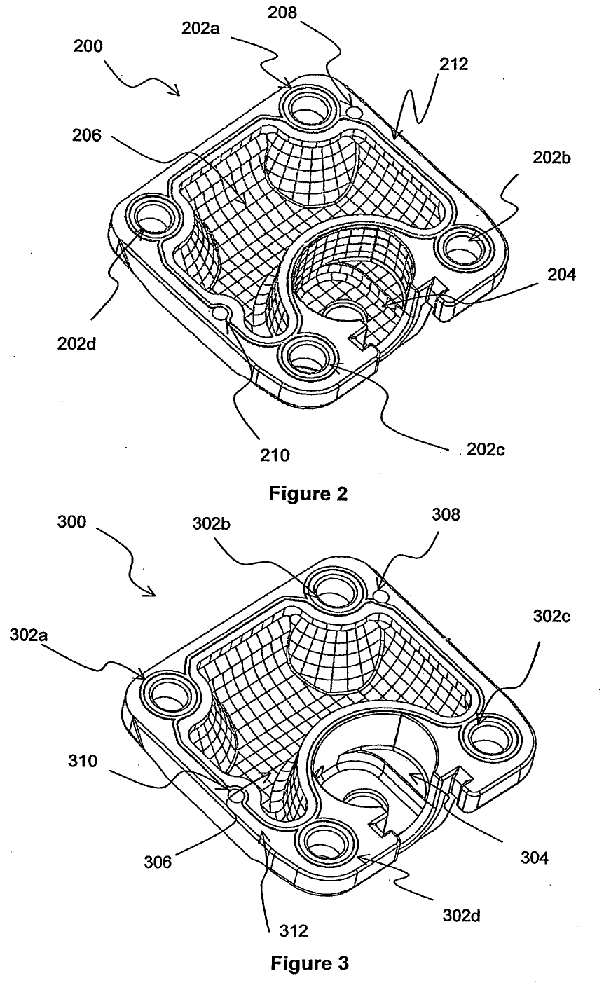

Referring to FIG. 2, a cylinder head 200 is exposed to show its interior structure. The cylinder head 200 is generally rectangular in shape with its four corners rounded off. At the four corners, four equal sized apertures 202a˜d are provided for bolting the cylinder head with a cylinder body (not shown) of a compressor. At a rim 212 of the cylinder head 200, two alignment holes 208, 210 for pin valve guide (not shown), providing reference guide for the valve plate assembly (not shown) for mating the cylinder head 200 with the cylinder body (not shown) during bolting. Within the surrounding rim, a discharge plenum 206 partially surrounds a suction plenum 204. Both the discharge plenum 206 and/or the suction plenum 204 are coated with respective layers, indicated as meshed contours in FIG. 2, of thermally insulting material at their interior surfaces for thermal insulation by providing thermal barrier layers additional to the thermal barrier provided by the cylinder head 200 material. For example, Al₂O₃, ZrO or Zirconia can be used for forming the thermal barrier layers via thermal spray (e.g., using flame, plasma, arc) or vacuum coating. With the layers of thermally insulating material, heat resistance is increased between the two plenums 206, 204 so that received low temperature gas has less possibility to be heated as a result of the presence of the compressed high temperature gas inside the neighbouring discharging plenum 206. Furthermore, heat from other heat sources inside the shell of the compressor such as the cylinder body itself is also hindered from escalating the gas temperature inside the suction plenum 204 prior to compression.

Referring to FIG. 3, another cylinder head 300 is exposed to show its interior structure. The generally rectangular shaped cylinder head 300 also has four bolting apertures 302a˜d distributed at its four corners. There is also a rim 312 provided for sealing and two alignment holes 308, 310 for pin valve guide (not shown), providing reference guide for the valve plate assembly (not shown) are made for locating the cylinder 300 to a cylinder body (not shown) in alignment. Inside the cylinder head 300, only the discharge plenum 306 is coated at its interior surface with a layer, indicated as meshed contour, of thermally insulating material for providing a thermal barrier layer in addition to the thermal barrier formed by the cylinder head 300 material. The discharge plenum may be coated with a layer of Al₂O₃, AlO or ZrO or other thermally insulating materials. It will be appreciated that in an alternative embodiment, only the suction plenum may be coated with a thermally insulating material at its interior surface.

Additionally or alternatively, further barrier layer(s) may be formed on the outer surface of the cylinder head.

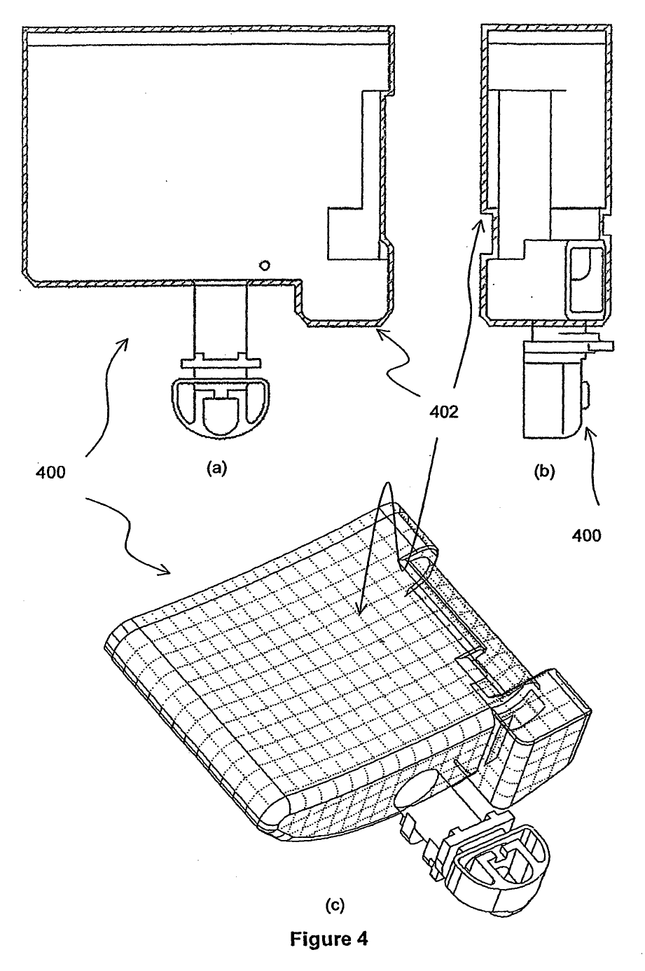

Referring to FIG. 4a-c, there is shown a suction muffler 400. The external surface 402 of the muffler 400 is coated with a layer of thermal insulating material AlO indicated as meshed contour for providing a thermal barrier layer additional to the muffler 400 material. The layer of the thermal insulating material increases thermal resistance for the muffler 400 so that external heat is hindered from being transferred to the interior of the muffler 400 and the gas received at the suction plenum connected to the muffler 400 can be maintained at a lower temperature. Alternatively, Al₂O₃, ZrO or other ceramic-based materials, or other thermal insulating materials may be used for coating.

In an alternative implementation, a thermal barrier layer may be provided in the form of an air layer in a suction muffler having a multi-walled design, e.g. a double walled design with an air gap between the double walls to achieve better thermal insulation of the gas as it passes through the muffler. The air gap provides a thermal barrier layer additional to the wall material of the double walled wall. The double walled design muffler may e.g. be formed from plastic material. An external coating may additionally be provided in such an implementation, to provide an additional thermal barrier layer for the muffler design. The double walled structure may be formed by multi-shot moulding, insert moulding, co-injection moulding or other suitable techniques.

The example implementations described above with reference to FIGS. 2 to 4 can provide a compressor structure in which one or more thermal barrier layers additional to a thermal barrier provided by respective materials of which components of the compressor are formed, can improve the thermal insulation such that the suction gas temperature in the compressor structure may be reduced. Since a reduction in the suction gas temperature decreases its specific volume and increases the mass flow rate of the refrigerant, this can lead to improved compressor efficiency due to an increase in cooling performance. The provision of one or more thermal barrier layers in addition to the thermal barrier provided by the materials from which elements of the compressor are formed advantageously increases a thermal insulation optimisation in allowing an independent choice of materials to form the components on the one hand, and the type of additional thermal barrier layer to be chosen on the other hand. Therefore, the described implementations may improve design choices to independently optimise the thermal insulation performance on the one hand, and the structural design and integrity of the components on the other hand.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

Furthermore, while example implementations of a cylinder head and a suction muffler have been described, it will be appreciated that in different implementations, a thermal barrier layer can be provided on other components of the compressor structure, additional to a thermal barrier formed by respective materials of the other components, such as e.g. on pipe or conduit elements of the compressor structure.

1. A compressor structure for a refrigeration system, the compressor structure comprising:
a compression cylinder;
a suction line leading gas to be compressed towards the cylinder; and
a discharge line leading the compressed gas away from the cylinder;
wherein at least one component of the suction line, the discharge line, or both comprises a thermal barrier layer on a surface of the at least one component.

2. The compressor structure as claimed in claim 1, wherein the thermal barrier layer is disposed on an external surface of the component.

3. The compressor structure as claimed in claim 1, wherein the thermal barrier layer is disposed on an internal surface of the component.

4. The compressor structure as claimed in claim 1, wherein the thermal barrier layer comprises a coating formed on the surface.

5. The compressor structure as claimed in claim 1, wherein the thermal barrier layer comprises a thermally insulating material.

6. The compressor structure as claimed in claim 5, wherein the thermally insulating material comprises one or more of a group consisting of a ceramic material, AlO, ZrO and Al₂O₃.

7. The compressor structure as claimed in claim 6, wherein the component comprises a suction muffler or a cylinder head.

8. The compressor as claimed in claim 7, wherein the coating is formed on an internal surface of a suction plenum, a discharge plenum, or both, of the cylinder head.

9. The compressor as claimed in claim 7, wherein the coating is formed on an external surface of the suction muffler.

10. The compressor structure as claimed in claim 1, wherein the thermal barrier layer comprises an air layer between adjacent walls of a multilayer wall structure of the component.

11. The compressor structure as claimed in claim 10, wherein the component comprises a suction muffler.

12. A component for integration in a suction line, a discharge line, or both, of a compressor structure for a refrigeration system, the component comprising a thermal barrier layer on a surface of the component.

13. The component as claimed in claim 12, wherein the thermal barrier layer is disposed on an external surface of the component.

14. The component as claimed in claim 12, wherein the thermal barrier layer is disposed on an internal surface of the component.

15. The component as claimed in claim 12, wherein the thermal barrier layer comprises a coating formed on the surface.

16. The component as claimed in claim 12, wherein the thermal barrier layer comprises a thermally insulating material.

17. The component as claimed in claim 16, wherein the thermally insulating material comprises one or more of a group consisting of a ceramic material, AlO, ZrO and Al₂O₃.

18. The component as claimed in claim 16, wherein the component comprises a suction muffler or a cylinder head.

19. The compressor as claimed in claim 18, wherein the coating is formed on an internal surface of a suction plenum, a discharge plenum, or both, of the cylinder head.

20. The compressor as claimed in claim 18, wherein the coating is formed on an external surface of the suction muffler.

21. The component as claimed in claim 12, wherein the thermal barrier layer comprises an air layer between adjacent walls of a multilayer wall structure of the component.

22. The component as claimed in claim 21, wherein the component comprises a suction muffler.

23. A method of fabricating a compressor structure for a refrigeration system, the method comprising:
providing a compression cylinder;
providing a suction line leading gas to be compressed towards the cylinder;
providing a discharge line leading the compressed gas away from the cylinder; and
forming a thermal barrier layer on a surface of at least one component of the suction line, the discharge line, or both.
